(19) United States
(12) Patent Application Publication
(10) Pub. No.: US 2012/0197784 A1
(43) Pub. Date: Aug. 2, 2012

(54) COMPENSATING AN INDIVIDUAL INVOLVED IN A BUSINESS

(75) Inventors: Troy W. Muhlestein, Springville, UT (US); Richard T. Smith, Orem, UT (US); Jon P. Holbrook, Draper, UT (US)

(73) Assignee: Sequoia Growth Partners, LLC, Orem, UT (US)

(21) Appl. No.: 13/194,809

(22) Filed: Jul. 29, 2011

Related U.S. Application Data
(60) Provisional application No. 61/368,961, filed on Jul. 29, 2010.

(51) Int. Cl. G06Q 20/22

(52) U.S. Cl. 705/39

(57) ABSTRACT

A method of compensating an individual involved in a business is disclosed. The method comprises putting money from a business into an accumulation pool. Further, the method comprises allowing an individual involved in the business to participate in the accumulation pool after the individual has satisfied pool participation criteria. The pool participation criteria being defined in part by a number of individuals involved in the business as a result of the individual. Still further, the method comprises determining a share of the accumulation pool for the individual and determining a percentage of the share to be paid to the individual according to share percentage criteria. The share percentage criteria being defined in part by the number of individuals involved in the business as a result of the individual. Additionally, the method comprises paying the individual an amount from the accumulation pool according to the percentage of the share.

### RELATED APPLICATIONS

This application claims the benefit of U.S. Provisional Application No. 61/368,961, filed Jul. 29, 2010, which is incorporated herein by reference.

### BACKGROUND

Businesses have a variety of ways for compensating individual business members. One business type, commonly known as direct marketing, compensates individuals for sales of a company's products as well as for sales by people that an individual introduces to the company. Compensation plans and incentives vary greatly among such companies. Some compensation plans offer extremely high payouts, however, such high payouts may not be sustainable. Often, direct marketing companies reward only the most successful individuals. In other words, compensation plans may be setup to provide very high payouts to the people at the top, but high payouts may be almost impossible for a new or average business member to achieve. Thus, there is a need for a compensation plan that pays well to the newer or average business member as well as to those who are top performers.

### SUMMARY

A method and system for compensating an individual involved in a business is disclosed and described. The method can comprise utilizing a matrix organizational structure for individuals involved in a business. The method can also comprise putting money generated from the business structured in the matrix organizational structure into an accumulation pool. The method can further comprise allowing an individual involved in the business to participate in the accumulation pool after the individual has satisfied pool participation criteria, the pool participation criteria being defined in part by a number of individuals involved in the business as a result of the individual. Still further, the method can comprise determining a share of the accumulation pool for the individual. Even further, the method can comprise, determining a percentage of the share to be paid to the individual according to share percentage criteria, the share percentage criteria being defined in part by the number of individuals involved in the business as a result of the individual. Additionally, the method can comprise paying the individual an amount from the accumulation pool according to the percentage of the share.

In another aspect, another method of compensating an individual involved in a business is provided. The method can comprise putting money generated from a business having a matrix organizational structure into a first accumulation pool. The method can also comprise allowing an individual involved in the business to participate in the first accumulation pool after the individual has satisfied pool participation criteria for the first accumulation pool, the pool participation criteria for the first accumulation pool being defined in part by a number of individuals involved in the business as a result of the individual. The method can further comprise determining a share of the first accumulation pool for the individual. Still further, the method can comprise determining a percentage of the share of the first accumulation pool to be paid to the individual according to share percentage criteria for the first accumulation pool, the share percentage criteria for the first accumulation pool being defined in part by the number of individuals involved in the business as a result of the individual. Additionally, the method can comprise paying the individual an amount from the first accumulation pool according to the percentage of the share for the first accumulation pool.

In yet another aspect, a system for determining compensation of an individual involved in a business is provided. The system can comprise a computing device. The system can also comprise an accumulation pool module to put money generated from a business having a matrix organizational structure into an accumulation pool. The system can further comprise a pool participation module to determine whether the individual has satisfied pool participation criteria and can participate in the accumulation pool, the pool participation criteria being defined in part by a number of individuals involved in the business as a result of the individual. Still further, the system can comprise a pool share module to determine a share of the accumulation pool for the individual. Even further, the system can comprise a share percentage module to determine a percentage of the share to be paid to the individual according to share percentage criteria, the share percentage criteria being defined in part by the number of individuals involved in the business as a result of the individual. Additionally, the system can comprise a payment module to determine an amount to be paid to the individual from the accumulation pool according to the percentage of the share.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a block diagram of a method of compensating an individual involved in a business in accordance with an embodiment of the present invention;

FIG. 2 illustrates a diagram of a matrix organizational structure for a business in accordance with an embodiment of the present invention;

FIG. 3 illustrates a diagram of an aspect of the method shown in FIG. 1;

FIG. 4 illustrates a diagram of another aspect of the method shown in FIG. 1;

FIG. 5 illustrates a diagram of yet another aspect of the method shown in FIG. 1;

FIG. 6 illustrates a diagram of still another aspect of the method shown in FIG. 1;

FIG. 7 illustrates a diagram of a further aspect of the method shown in FIG. 1;

FIG. 8 illustrates a diagram of a specific aspect of the method shown in FIG. 1; and

FIG. 9 illustrates a diagram of a system for compensating an individual involved in a business in accordance with an embodiment of the present invention.

### DETAILED DESCRIPTION

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only to describe the features and characteristics of the present invention, and to sufficiently enable one skilled in the art to practice the invention. Accordingly, the scope of the present invention is to be defined solely by the appended claims.

It must be noted that, as used in this specification and the appended claims, the singular forms “a,” “an,” and “the” include plural referents unless the context clearly dictates otherwise.

Any steps recited in any method or process claims may be executed in any order and are not limited to the order presented in the claims unless otherwise stated.

As used herein, a plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

The following detailed description and exemplary embodiments of the invention will be best understood by reference to the accompanying drawings, wherein the elements and features of the invention are designated by numerals throughout.

Each of the above-recited advantages will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

A method is provided for compensating an individual that can pay well to the newer or average business member, as well as to those who are top performers. For example, the method can include an accumulation pool for qualified members to participate in and share together. The payout from the pool can be capped at a predetermined currency value. Unpaid portions of any individual's share of the pool can remain in the pool, thus increasing the amount of funds in the pool. By capping an individual's payout from the pool, the pool can grow to be very large. This can increase the size of the share available to newer or average individuals participating in the pool. The existence of a cap can also be an incentive for pool participants to improve performance in order to reach the cap. Thus, in certain configurations, the cap can incentivize pool participants to reach the cap and then help others to reach the cap. Furthermore, the cap can apply to multiple forms of business payments to an individual, including a payment from the pool. On the other hand, some forms of business payments, other than a payment from the pool, can be exempt from the cap. In this case, an individual's total business payments from the company for a given period may exceed the cap. Thus, there is an incentive for further achievement and productivity by the individuals that have reached the cap.

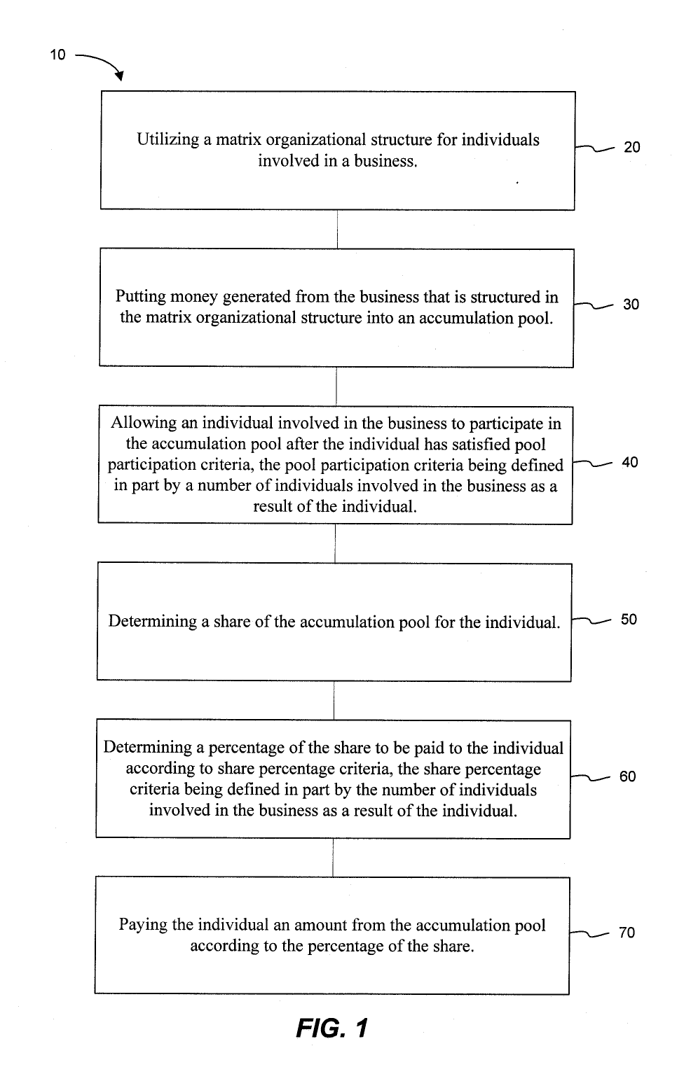

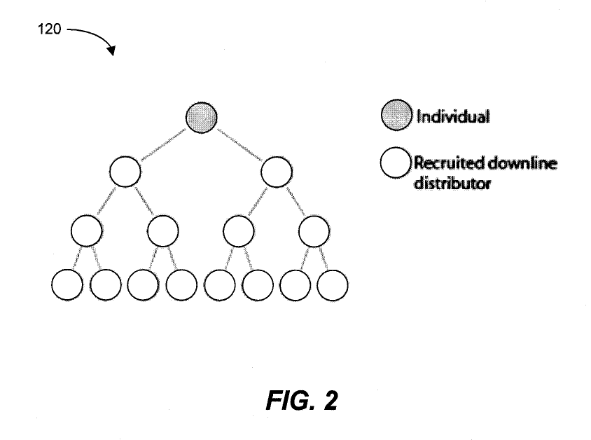

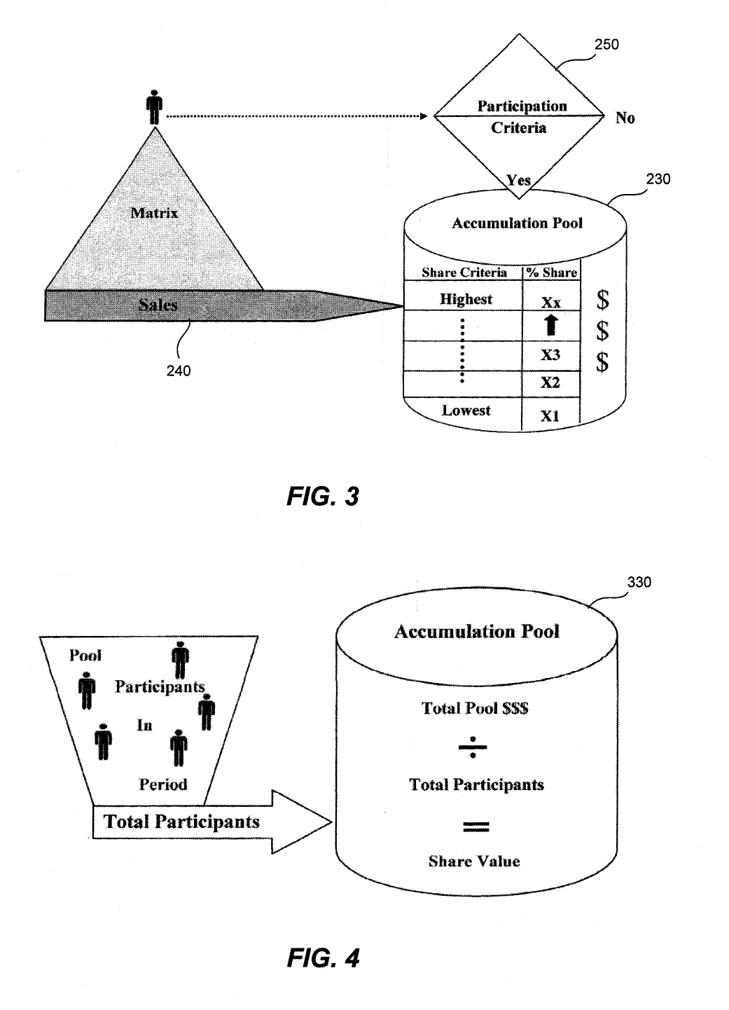

In accordance with an embodiment of the present disclosure, FIG. 1 illustrates a block diagram of a method 10 of compensating an individual involved in a business. Certain aspects of the method illustrated in FIG. 1 are shown in FIGS. 3-8. One operation, illustrated at block 20, can be utilizing a matrix organizational structure for individuals involved in a business. An example of a matrix organizational structure 120 is shown in FIG. 2. Typically, businesses that utilize a matrix organizational structure include network marketing, direct selling, and referral marketing businesses. The matrix structure is designed to create a marketing and sales force by compensating promoters of company products not only for sales they personally generate, but also for the sales of other promoters they bring into the company, creating a downline of distributors and a hierarchy of multiple levels of compensation. The products and company are usually marketed directly to consumers and potential business partners by means of relationship referrals and word of mouth marketing.

Independent, unsalaried salespeople of direct marketing companies, referred to as distributors (or associates, independent business owners, dealers, franchise owners, sales consultants, consultants, independent agents, etc.), represent the company that produces the products or provides the services the distributors sell. The distributors can be awarded a commission based upon the volume of product sold through their own sales efforts as well as the sales of their downline organization. Independent distributors can develop their own organizations by building an active customer base, who buy direct from the company, or by recruiting a downline of independent distributors who also build a customer base, thereby expanding the overall organization, or by some combination of selling and recruiting. Additionally, distributors can also earn a profit by retailing products purchased from the company at wholesale price.

Thus, this arrangement allows distributors to earn a commission based on the sales of their independent efforts as well as the leveraged sales efforts of their downline. Commissions can be paid to direct marketing distributors according to the company's compensation plan. There can be individuals at multiple levels of the structure receiving royalties from a single person's sales.

A business can establish criteria for paying money to individuals involved in the business. For example, the business can require that a distributor be current on business membership fees. In this case, the distributor may be referred to as an “active member” of the business. An active member can qualify to receive payments from the company. For example, an active member can qualify to receive money based on the number of individuals involved or enrolled in the business as a result of the member. Such a member can be referred to as a Qualified Representative. In some embodiments, an active member can be a Qualified Representative if two individuals have become involved in the business as a result of the member. A Qualified Representative can qualify to receive additional money from the business, as described further below.

Of course, it should be noted that in certain aspects of the method a business structure that is not a matrix structure can be utilized. For example, a business structure can be a partnership, corporation, cooperative, or any other type or form of business and is not to be limited to a matrix organizational structure.

Another operation, illustrated at block 30 of FIG. 1 and in FIG. 3, can be putting money generated from the business structured in the matrix organizational structure into an accumulation pool 230. An accumulation pool can be created by the business as a way to pay money to certain Qualified Representatives. The accumulation pool can include money generated from sales 240 of products and/or services, membership fees, or any other revenue source available to the business. In one aspect, the accumulation pool can include a percentage of total business sales. In another aspect, the accumulation pool can include money generated by a member of the business who has forfeited his/her position in the matrix organizational structure, i.e. by quitting the business. For example, if the business chooses, the business can maintain the position in the matrix organizational by paying the membership fee for the position out of commissions generated by the position. Money left over from the membership fee can be put in the accumulation pool.

An additional operation, illustrated at block 40 and in FIG. 3, can be allowing an individual involved in the business to participate in the accumulation pool after the individual has satisfied pool participation criteria 250. An individual's involvement in the business can be as someone that is associated with the business and receives money from the business. For example, a partner, employee, consultant, contractor, or other person that is hired by and/or represents the business (such as a distributor of a direct marketing company) can be considered “involved” in the business. In contrast, a mere customer is not “involved” in the business within the meaning of the present disclosure. Individuals participating in the accumulation pool can receive money from the business via the accumulation pool. The business can establish any criteria for participating in the accumulation pool. For example, the pool participation criteria can be based on the length of time that an individual has been involved with the business and/or an individual meeting a specified sales quota. In one embodiment, the pool participation criteria can be defined in part by a number of individuals involved in the business as a result of the individual.

For example, an individual who has involved four individuals in the business can qualify to participate in the accumulation pool. In one specific aspect, a Qualified Representative who has helped four individuals to become Qualified Representatives can participate in the accumulation pool. Such an individual may be known as an Executive-4. Accordingly, in another specific aspect, an Executive-5 can be a Qualified Representative who has helped five individuals to become Qualified Representatives. Further, an Executive-6 can be a Qualified Representative who has helped six individuals to become Qualified Representatives. Still further, an Executive-7 can be a Qualified Representative who has helped at least seven individuals to become Qualified Representatives. Thus, in this specific example, an individual who has qualified to participate in the accumulation pool is termed an “Executive.”

A further operation, illustrated at block 50, can be determining a share of the accumulation pool for the individual. As illustrated in FIG. 4, in certain embodiments of the method, determining a share of the accumulation pool 330 for the individual comprises dividing the money in the accumulation pool by a total number of individuals participating in the accumulation pool. This would result in an equal share for each individual participating in the accumulation pool. In a specific example, each Executive receives one equal share, with the share being determined by dividing the amount of money in the accumulation pool by the total number of Executives. Alternatively, the share can be defined in part by the number of individuals involved in the business as a result of the individual. This could result in unequal shares for the individuals participating in the accumulation pool. For example, an individual who has brought more people into the business than another can receive a greater share of the accumulation pool.

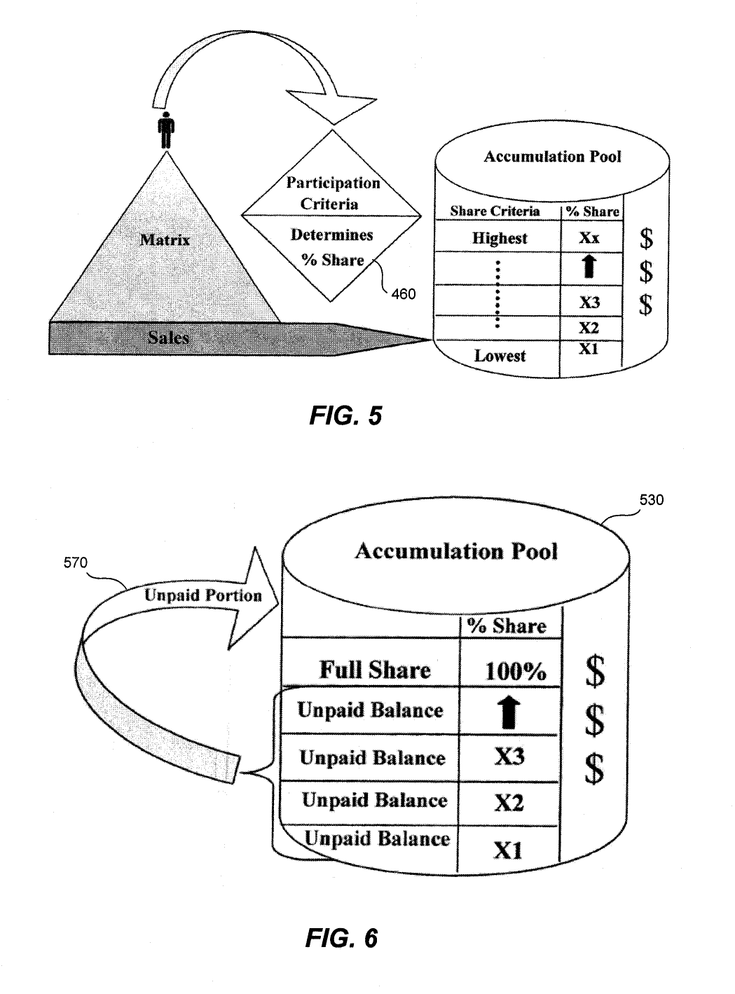

Yet another operation, illustrated at block 60, can be determining a percentage of the share to be paid to the individual according to share percentage criteria. The share percentage criteria can be defined in part by the number of individuals involved in the business as a result of the individual. As illustrated in FIG. 5, in certain embodiments of the method, determining a percentage of the share 460 to be paid to the individual comprises determining which one of a plurality of percentages the individual is to be paid, wherein the percentage of the share generally increases as the number of individuals involved in the business as a result of the individual increases. In one example, the plurality of percentages can include percentages that are less than or equal to 100%. In another example, the plurality of percentages can include percentages that are greater than 100%. In a specific example, share percentage criteria can dictate that an Executive-4 can be paid 15% of the share, an Executive-5 can be paid 30% of the share, an Executive-6 can be paid 60% of the share, and an Executive-7 can be paid 100% of the share.

Still another operation, illustrated at block 70, can be paying the individual an amount from the accumulation pool according to the percentage of the share. As illustrated in FIG. 6, in certain embodiments of the method, an unpaid portion 570 of the share can remain in the accumulation pool 530. In a specific example, 85% of an Executive-4 share can remain in the pool, 70% of an Executive-5 share can remain in the pool, 40% of an Executive-6 share can remain in the pool, and none of an Executive-7 share to remain in the pool.

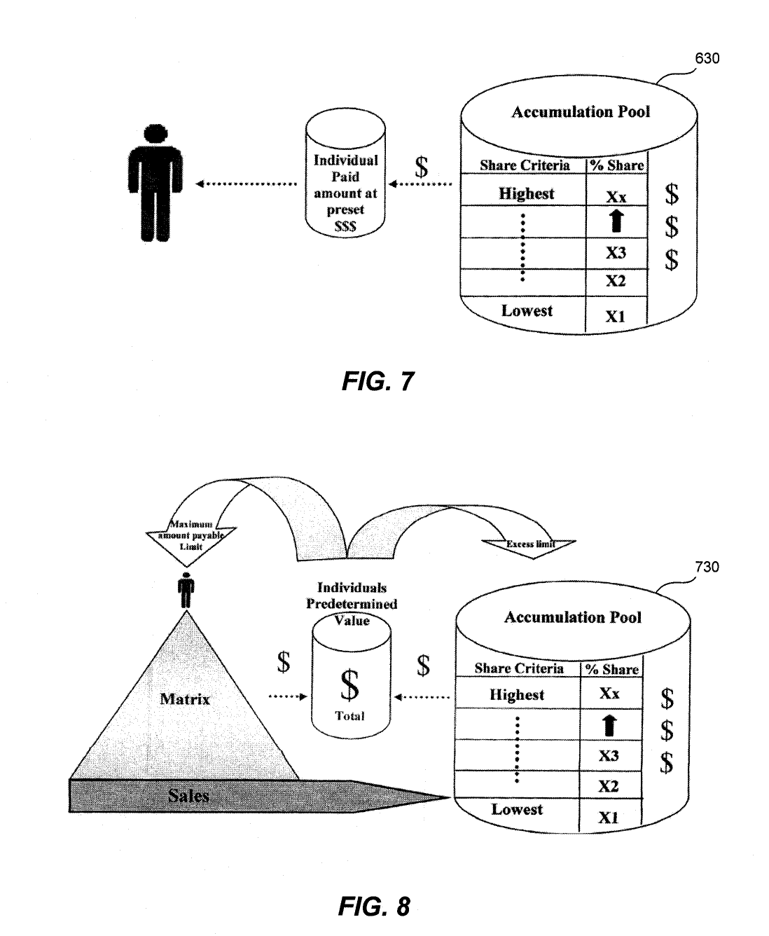

As illustrated further in FIG. 7, in certain aspects, a maximum amount payable to the individual from the accumulation pool 630 can be limited to a predetermined currency value. In other words, a cap on the amount paid to an individual from the pool can be capped at a certain amount. The unpaid portion, in excess of the cap, can remain in the pool. For example, the maximum amount payable to an individual may have a predetermined currency value, or cap, of $10,000 per time period. According to the pool participation and share percentage criteria, one individual participating in the pool may be eligible to be paid an amount in excess of $10,000. However, due to the cap, the amount in excess of $10,000 will remain in the pool per time period. Distributions from the pool can be at any time desired by the business. For example, distributions can occur at regular intervals of one week, two weeks, one month, one quarter, one year, or any other interval selected by the business. On the other hand, distributions can occur at non-uniform intervals.

As illustrated in FIG. 8, in one aspect, a sum of the amount from the accumulation pool 730 and an amount of a second business payment can be limited to the predetermined currency value. For example, the business can implement more than one payment configuration for individuals or distributors. A first payment configuration can include payments from the accumulation pool. A second payment configuration can be based on a different set of criteria from the accumulation pool. However, both the first and the second payment configurations can be subject to the same maximum amount payable or cap. In one aspect, the amount to be paid from the accumulation pool will be paid first, followed by the amount to be paid from the second payment configuration, if there is any room under the cap. For example, a cap can be set at $10,000. The amount payable to an individual from the accumulation pool can be $9,000. Therefore, the amount paid to the individual would be $9,000 from the pool and up to $1,000 from the second payment configuration. On the other hand, the amount payable to an individual from the pool can be in excess of $10,000. In this case, the individual is paid $10,000 from the pool and, since there is no room left under the cap, nothing is paid to the individual from the second payment configuration. Of course, the priority of the payment configurations can be reversed from the previous example. For instance, money from the second payment configuration can be allocated first, followed by any applicable payment from the accumulation pool. Further, payment configurations subject to the cap can be allocated in any percentage between the configurations in order to limit the total paid to the cap amount.

In another aspect, an amount of a second business payment can be exempted from the maximum amount payable limit. As above, the business can have more than one payment configuration. However, in this case, the third payment configuration can be exempt from the cap. For example, a cap can be set at $10,000. The amount payable to an individual from the accumulation pool can be $9,000. Therefore, the amount paid to the individual would be $9,000 from the pool and the entire amount due from the third payment configuration, since the third payment configuration is not limited by the cap. As a further example, the amount payable to an individual from the pool can be in excess of $10,000. In this case, the individual is paid $10,000 from the pool and, since the third payment configuration is exempt from the cap, the individual is paid the entire amount due from the third payment configuration.

Of course, since the business can have more than one payment configuration, any number of payment configurations can be included or exempted from the cap. For example, a cap can be set at $10,000. The amount payable to an individual from the accumulation pool can be $9,000. The second payment configuration can be included in the cap and the third payment configuration can be exempted from the cap. Therefore, the amount paid to the individual would be $9,000 from the pool, up to $1,000 from the second payment configuration, and the entire amount due from the third payment configuration. As a further example, the amount payable to an individual from the pool can be in excess of $10,000. In this case, the individual is paid $10,000 from the pool, the individual is paid nothing from the second payment configuration since there is no room left under the cap, and the individual is paid the entire amount due from the third payment configuration since it is exempt from the cap. As mentioned above, the priority of the payment configurations subject to the cap can be in any order or in any percentage of allocation between the configurations.

One benefit that can be seen in the accumulation pool, due to the cap and/or unpaid portions of shares remaining in the pool, is that the accumulation pool funds can experience geometric growth. This helps to ensure that the accumulation pool can be adequate for an ever-increasing number of qualified participants.

In one aspect, a plurality of accumulation pools can be incorporated into a compensation plan. Thus, the aforementioned benefits of an accumulation pool can be realized for each accumulation pool. Furthermore, additional accumulation pools can expand the compensation plan to handle an increasing number of participants whose compensation has become capped in another accumulation pool. In general, each of the plurality of accumulation pools can be incorporated as discussed hereinabove.

Accordingly, a method of compensating an individual involved in a business can include putting money generated from the business into a second accumulation pool. The method can also include allowing the individual to participate in the second accumulation pool after the individual has satisfied pool participation criteria for the second pool, the second pool participation criteria being defined in part by a number of individuals involved in the business as a result of the individual. The method can further include determining a share of the second accumulation pool for the individual. Still further, the method can include determining a percentage of the share of the second accumulation pool to be paid to the individual according to share percentage criteria for the second accumulation pool, the share percentage criteria for the second accumulation pool being defined in part by the number of individuals involved in the business as a result of the individual. Additionally, the method can include paying the individual an amount from the second accumulation pool according to the percentage of the share for the second accumulation pool. In one aspect, the second pool participation criteria can be further defined by whether the amount payable from the first accumulation pool has been limited to a predetermined currency value.

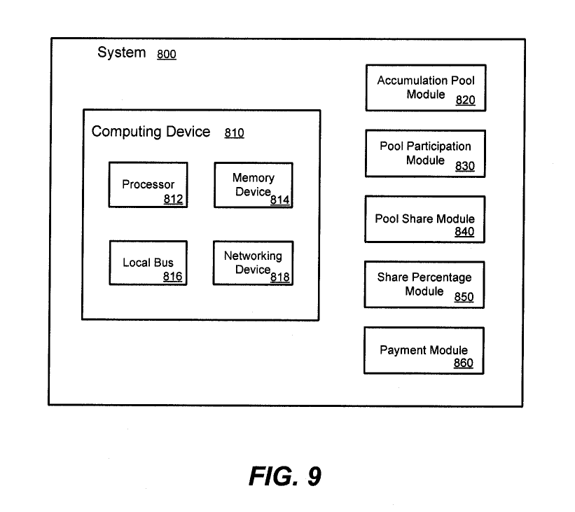

With reference to FIG. 9, illustrated is a system 800 for determining compensation of an individual involved in a business. The system 800 can include a computing device 810 with a hardware processor device 812, a hardware memory device 814, a local communication bus 816 to enable communication between hardware devices and components, and a networking device 818 for communication across a network with other computing systems or processes on the computing device. The system 800 can also include an accumulation pool module 820 to put money generated from a business having a matrix organizational structure into an accumulation pool. The system 800 can further include a pool participation module 830 to determine whether the individual has satisfied pool participation criteria and can participate in the accumulation pool, the pool participation criteria being defined in part by a number of individuals involved in the business as a result of the individual. Still further, the system 800 can include a pool share module 840 to determine a share of the accumulation pool for the individual. Even further, the system 800 can include a share percentage module 850 to determine a percentage of the share to be paid to the individual according to share percentage criteria, the share percentage criteria being defined in part by the number of individuals involved in the business as a result of the individual. Additionally, the system 800 can include a payment module 860 to determine an amount to be paid to the individual from the accumulation pool according to the percentage of the share. The module can use the processor and memory to complete operations assigned to each module.

In one aspect, an unpaid portion of the share remains in the pool. In another aspect, a share of the accumulation pool for the individual is determined by dividing the money in the accumulation pool by a total number of individuals participating in the accumulation pool. In still another aspect, a percentage of the share to be paid to the individual is determined by assessing which one of a plurality of percentages the individual is to be paid, wherein the percentage of the share generally increases as the number of individuals involved in the business as a result of the individual increases. In an additional aspect, a maximum amount payable to the individual from the accumulation pool is limited to a predetermined currency value. In a specific aspect, a sum of the amount from the accumulation pool and an amount of a second business payment is limited to the predetermined currency value. In another specific aspect, an amount of a second business payment is exempted from the maximum amount payable limit.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. Accordingly, the scope of the invention should be determined solely by the appended claims and their legal equivalents, rather than by the descriptions and examples given above.

What is claimed is:

1. A method of compensating an individual involved in a business, comprising:
utilizing a matrix organizational structure for individuals involved in a business;
putting money generated from the business structured in the matrix organizational structure into an accumulation pool;
allowing an individual involved in the business to participate in the accumulation pool after the individual has satisfied pool participation criteria, the pool participation criteria being defined in part by a number of individuals involved in the business as a result of the individual;
determining a share of the accumulation pool for the individual;
determining a percentage of the share to be paid to the individual according to share percentage criteria, the share percentage criteria being defined in part by the number of individuals involved in the business as a result of the individual; and
paying the individual an amount from the accumulation pool according to the percentage of the share.

2. The method of claim 1, wherein an unpaid portion of the share remains in the pool.

3. The method of claim 1, wherein determining a share of the accumulation pool for the individual comprises dividing the money in the accumulation pool by a total number of individuals participating in the accumulation pool.

4. The method of claim 1, wherein determining a percentage of the share to be paid to the individual, comprises determining which one of a plurality of percentages the individual is to be paid, wherein the percentage of the share generally increases as the number of individuals involved in the business as a result of the individual increases.

5. The method of claim 1, wherein a maximum amount payable to the individual from the accumulation pool is limited to a predetermined currency value.

6. The method of claim 5, wherein a sum of the amount from the accumulation pool and an amount of a second business payment is limited to the predetermined currency value.

7. The method of claim 5, wherein an amount of a second business payment is exempted from the maximum amount payable limit.

8. A method of compensating an individual involved in a business, comprising:
putting money generated from a business into a first accumulation pool;
allowing an individual involved in the business to participate in the first accumulation pool after the individual has satisfied pool participation criteria for the first accumulation pool, the pool participation criteria for the first accumulation pool being defined in part by a number of individuals involved in the business as a result of the individual;
determining a share of the first accumulation pool for the individual;
determining a percentage of the share of the first accumulation pool to be paid to the individual according to share percentage criteria for the first accumulation pool, the share percentage criteria for the first accumulation pool being defined in part by the number of individuals involved in the business as a result of the individual; and
paying the individual an amount from the first accumulation pool according to the percentage of the share for the first accumulation pool.

9. The method of claim 8, wherein an unpaid portion of the share remains in the first accumulation pool.

10. The method of claim 8, wherein determining a share of the first accumulation pool for the individual comprises dividing the money in the first accumulation pool by a total number of individuals participating in the first accumulation pool.

11. The method of claim 8, wherein determining a percentage of the share of the first accumulation pool to be paid to the individual comprises determining which one of a plurality of percentages the individual is to be paid, wherein the percentage of the share generally increases as the number of individuals involved in the business as a result of the individual increases.

12. The method of claim 8, wherein a maximum amount payable to the individual from the first accumulation pool is limited to a predetermined currency value.

13. The method of claim 12, wherein a sum of the amount from the first accumulation pool and an amount of a second business payment is limited to the predetermined currency value.

14. The method of claim 12, wherein an amount of a second business payment is exempted from the maximum amount payable limit.

15. The method of claim 8, further comprising:
putting money generated from the business into a second accumulation pool;
allowing the individual to participate in the second accumulation pool after the individual has satisfied pool participation criteria for the second pool, the second pool participation criteria being defined in part by a number of individuals involved in the business as a result of the individual;
determining a share of the second accumulation pool for the individual;
determining a percentage of the share of the second accumulation pool to be paid to the individual according to share percentage criteria for the second accumulation pool, the share percentage criteria for the second accumulation pool being defined in part by the number of individuals involved in the business as a result of the individual; and
paying the individual an amount from the second accumulation pool according to the percentage of the share for the second accumulation pool.

16. The method of claim 15, wherein the second pool participation criteria is further defined by whether the amount payable from the first accumulation pool has been limited to a predetermined currency value.

17. A system for determining compensation of an individual involved in a business, comprising:
a computing device;
an accumulation pool module to put money generated from a business having a matrix organizational structure into an accumulation pool;
a pool participation module to determine whether the individual has satisfied pool participation criteria and can participate in the accumulation pool, the pool participation criteria being defined in part by a number of individuals involved in the business as a result of the individual;
a pool share module to determine a share of the accumulation pool for the individual;
a share percentage module to determine a percentage of the share to be paid to the individual according to share percentage criteria, the share percentage criteria being defined in part by the number of individuals involved in the business as a result of the individual; and
a payment module to determine an amount to be paid to the individual from the accumulation pool according to the percentage of the share.

18. The system of claim 17, wherein an unpaid portion of the share remains in the pool.

19. The system of claim 17, wherein a share of the accumulation pool for the individual is determined by dividing the money in the accumulation pool by a total number of individuals participating in the accumulation pool.

20. The system of claim 17, wherein a percentage of the share to be paid to the individual is determined by assessing which one of a plurality of percentages the individual is to be paid, wherein the percentage of the share generally increases as the number of individuals involved in the business as a result of the individual increases.

21. The system of claim 17, wherein a maximum amount payable to the individual from the accumulation pool is limited to a predetermined currency value.

22. The system of claim 21, wherein a sum of the amount from the accumulation pool and an amount of a second business payment is limited to the predetermined currency value.

23. The system of claim 21, wherein an amount of a second business payment is exempted from the maximum amount payable limit.
